(19) United States
(12) Patent Application Publication
(10) Pub. No.: US 2009/0249539 A1
(43) Pub. Date: Oct. 8, 2009

(54) Inside/Outside fitting for plumbing apparatus and system

(76) Inventor: Michael Holtsnider, Moorpark, CA (US)

Correspondence Address: KOPPEL, PATRICK, HEYBL & DAWSON, 2815 Townsgate Road, SUITE 215, Westlake Village, CA, 91361-5827, US

(21) Appl. No.: 12/383,994

(22) Filed: Mar. 30, 2009

Related U.S. Application Data
(60) Provisional application No. 61/072,247, filed on Mar. 28, 2008.

(51) Int. Cl. B05B 1/02; F16K 11/00

(52) U.S. Cl. 4/541.6; 137/597; 137/1

(57) ABSTRACT

A plumbing apparatus and method for pools, spas and the like is provided. In one embodiment, a jet assembly may be provided, with the assembly comprising a jet body and one or more inside/outside fittings extending from the body. The one or more fittings are substantially hollow. At least one water supply hose is provided, with the hose sized to fit snugly inside the one or more hollow fittings or sized to fit snugly around the exterior of the one or more fittings. A plumbing system may also be provided, with the system comprising a manifold with a main body and a plurality of inside/outside fittings extending from the body. A plurality of spa accessories is also provided, with each of the accessories comprising at least one inside/outside fitting. Further, a plurality of supply hoses is provided, with one end of each hose sized to fit snugly inside or around the exterior of the manifold fittings, and the other end of each hose sized to fit snugly inside or around the exterior of the spa accessory fittings.

This application claims the benefit of provisional application Ser. No. 61/072,247 to Mike Holtsnider, which was filed on Mar. 28, 2008.

### BACKGROUND OF THE INVENTION

1. Field of the Invention

This invention relates to plumbing for water reservoirs and more particularly to inside/outside fittings for plumbing components for use with multiple jets and/or spa accessories in pools, spas and the like.

2. Description of the Related Art

Various hydrotherapy jets, jet systems and other water-related accessories such as valves and waterfalls (collectively “jets”) have been developed for use in spas, hot tubs, pools, bath tubs and the like (“spa”). Jets can be arranged to discharge a stream of water to the interior of the spa, which can be aerated through a variety of commercially available discharge nozzles. The various designs provide different characteristics that produce pleasing effects for the spa occupants, and have become quite popular. In the design of single or multi-user spas or tubs, it is common to use a variety of different jet nozzles and/or other spa accessories to provide a variety of different effects.

There are numerous types of jets that have been developed over the years, which can be placed in a variety of locations and arrangements within a spa. For example, jets have been developed in which the direction of the stream can be adjusted, such as in U.S. Pat. No. 5,269,029 to Spears et al. (assigned to the same assignee as the present invention). Other jets have been developed having fully adjustable directional outlets or ball housings, which are typically mounted in the face plate of the jet or recessed within the jet body. See, e.g., Waterway Plastics Inc., “2005 Product Catalog”, pages 5-26. Still other jets have been developed that produce a pulsating stream of water using a variety of approaches to disturb the flow of water as it projects into the spa, such as in U.S. Pat. No. 4,456,174 to J. Neenan, U.S. Pat. No. 4,320,541 also to J. Neenan, U.S. Pat. No. 5,014,372 to L. Thrasher et al., and U.S. Pat. No. 5,920,925 to Dongo. Furthermore, still other jets have been developed that produce a massaging effect using balls.

Since there are countless types of jets, it follows that there are various fittings, components, and mechanisms for allowing the jets to work properly in a spa. There are limited means by which to connect the varying types of jets to spa plumbing systems so they can be operative throughout a spa while still taking advantage of shared conduit systems that provide water and/or air throughout a spa system to enable them to function properly. One way to provide water to jets is to plumb them in a loop system as commonly known in the art. However, a loop system limits the number of jets that can be added to each spa.

To increase the number of jets that can be connected to a common plumbing system, manifolds have been provided. See, e.g., Waterway Plastics Inc., “2008 Product Catalog”, pages 33-42. Such manifolds are connected to the primary plumbing system and comprise a plurality of outlets to which a plurality of jets can be connected via hoses that fit snugly over the outlets. However, due to the varying sizes and functions of various jets, the jets will have differing fittings at their water inlet points and/or varying water capacities, which will require corresponding hoses of appropriate length and diameter for delivering water optimally. Also, plumbing systems tend to taper down in size as they reach smaller and smaller components, which makes the utility of varying hoses/conduits more desirable.

To accommodate the fittings and water capacity of these varying jets, manifolds with a plurality of different outlet sizes have been provided. For example, the manifolds by Magic Plastics, Inc. allow for the connection of a variety of jets by providing multiple outlets of varying sizes over which the hoses for varying jets may be attached. However, while such an arrangement allows for the connection of a variety of jet sizes and types, these manifolds are designed such that the end of each jet's hose must be connected by being placed over the outer circumference of each manifold outlet. When a hose must always be connected to the outside of a fitting in this manner, the hose necessarily has a larger interior diameter than the inside of the fitting, meaning it carries more water to the fitting than the fitting can accommodate. This can be undesirable when a smaller jet or spa accessory with less water capacity is desired. Furthermore, as the hoses decrease in diameter, fitting them over fittings designed to accommodate smaller jets can cause the water flow to undesirably constrict.

Another approach for plumbing systems in which smaller and smaller components are utilized is to provide reducers within the plumbing system as commonly known in the art. For example, reducers similar to those sold in various home improvement stores can be incorporated into plumbing systems wherever a reduction in water flow is desired. However, spa systems are becomingly increasingly customizable, which complicates the plumbing systems necessary to accommodate the varying jets and other spa accessories common in many spas. Having to supply a reducer wherever the plumbing system tapers down would be unduly complicated. It is more desirable to utilize hoses appropriate to each spa component while providing a universal fitting for each hose type and spa accessory.

### SUMMARY OF THE INVENTION

The present invention seeks to provide universal inside/outside fittings and a method for spa plumbing with an improved and customizable approach to connecting jets and/or other spa accessories to a common water and/or air inlet system, with the fittings and method being durable, inexpensive, and incomplex. In at least embodiment according to the present invention, a jet assembly is provided comprising a jet body and one or more inside/outside fittings extending from the jet body, with the one or more fittings being substantially hollow. At least one water supply hose is provided, with each hose sized to fit snugly inside one or more hollow fittings or sized to fit snugly around the exterior of the one or more fittings.

In another embodiment according to the present invention, a plumbing system is provided comprising a manifold with a main body and a plurality of inside/outside fittings extending from the body. Furthermore, a plurality of spa accessories is provided, with each accessory comprising at least one inside/outside fitting. A plurality of supply hoses is also provided, wherein one end of each hose is sized to fit snugly inside or around the exterior of the manifold fittings, and wherein another end of each hose is sized to fit snugly inside or around the exterior of the at least one spa accessory fitting.

In another embodiment according to the present invention, a method is provided for a plumbing system. The method comprises providing one or more manifolds each with a main body, wherein a plurality of inside/outside fittings extends from each main body. One or more spa accessories is also provided, with each accessory comprising at least one inside/outside fitting. One or more supply hoses are provided, with each of the hoses fitting snugly either inside or around the exterior of the manifold and/or spa accessory inside/outside fittings. One end of the one or more supply hoses is then attached to the inside or around the exterior of at least one of each manifold inside/outside fittings, and the other end of the hose is attached to the inside or around the exterior of at least one of said spa accessory inside/outside fittings.

These and other further features and advantages of the invention will be apparent to those skilled in the art from the following detailed description, taken together with the accompanying drawings, in which:

### BRIEF DESCRIPTION OF THE DRAWINGS

FIG. 1 is a sectional view of one embodiment of a jet with an inside/outside fitting and connected hose according to the present invention;

FIG. 2 is a detailed sectional view of section F of the jet as shown in FIG. 1;

FIG. 3 is a sectional view with dimensions of the inside/outside fitting of the jet shown in FIG. 1;

FIG. 4 is a sectional view of one embodiment of a hose that can be connected to the jet as shown in FIG. 1;

FIG. 5 is a sectional view of one embodiment of a jet with an inside/outside fitting and connected hose according to the present invention;

FIG. 6 is a detailed sectional view of section E of the jet as shown in FIG. 5;

FIG. 7 is a sectional view with dimensions of the inside/outside fitting of the jet shown in FIG. 5;

FIG. 8 is a sectional view of one embodiment of a hose that can be connected to the jet as shown in FIG. 5;

FIG. 9 is a sectional view of one embodiment of a jet with an inside/outside fitting and connected hose according to the present invention;

FIG. 10 is a detailed sectional view of section F of the jet as shown in FIG. 9;

FIG. 11 is a sectional view with dimensions of the inside/outside fitting of the jet shown in FIG. 9;

FIG. 12 is a sectional view of one embodiment of a hose that can be connected to the jet as shown in FIG. 9;

FIG. 13 is a sectional view of one embodiment of a jet with an inside/outside fitting and connected hose according to the present invention;

FIG. 14 is a detailed sectional view of section E of the jet as shown in FIG. 13;

FIG. 15 is a sectional view with dimensions of the inside/outside fitting of the jet shown in FIG. 13;

FIG. 16 is a sectional view of one embodiment of a hose that can be connected to the jet as shown in FIG. 13; and

FIG. 17 is a perspective view of a plurality of jets and/or spa accessories using the new inside/outside fittings.

### DETAILED DESCRIPTION OF THE INVENTION

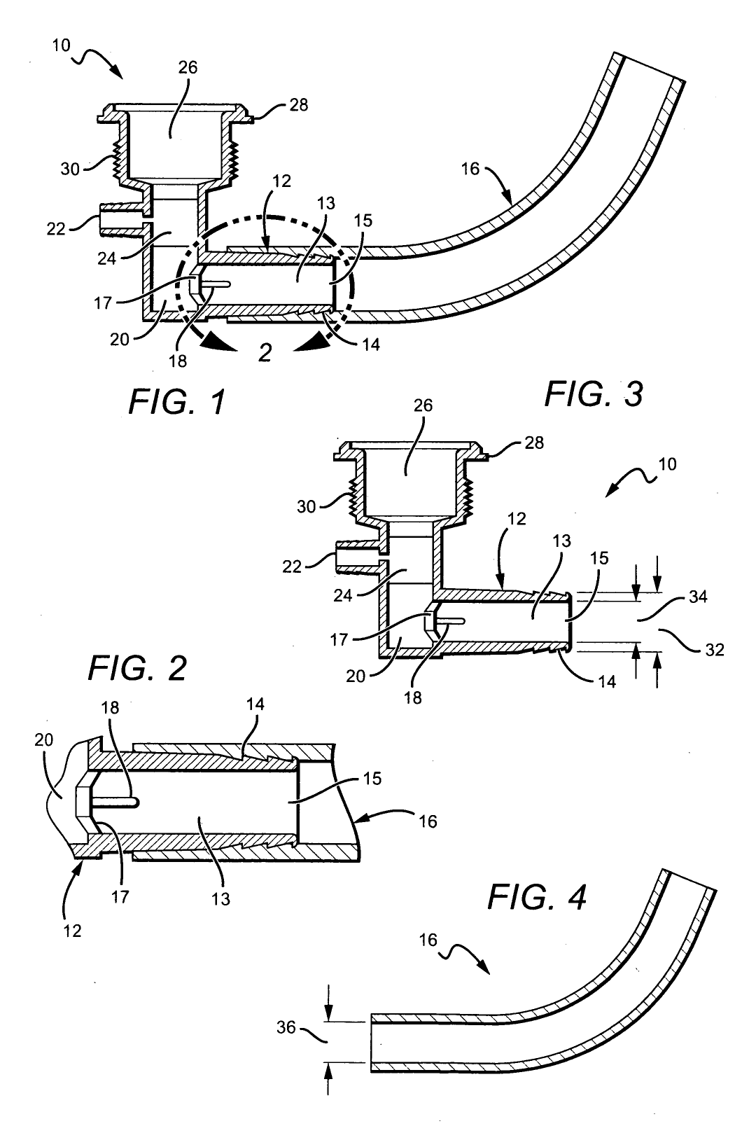

FIGS. 1-4 show one embodiment of a jet assembly 10 constructed in accordance with the present invention, having an inside/outside fitting 12, serrations 14 on the outside of fitting 12, water supply hose 16, hose stop 18, water chamber 20, air inlet 22, air chamber 24, main jet body 26, flange 28, and threads 30. The jet assembly 10 and its components (with the exception of hose 16) are preferably formed from a plastic such as PVC, ABS or CPVC, but can be formed from a number of different materials. Hose 16 is preferably formed from a clear vinyl, but can be formed from a number of different materials. While jet assembly 10 shows one preferred embodiment of a spa component comprising the new inside/outside fitting, it is understood that any number of spa and/or plumbing components such as manifolds, waterfalls, valves and the like may comprise at least one such fitting.

The inside/outside fitting 12 of the jet assembly 10 includes an elongated cylindrical barb 13 extending peripherally from said water chamber 20, with said body 13 having a first opening 15 opening to the outside of jet assembly 10 to accept water flowing through the hollow center of hose 16. The barb 13 has a second opening 17, with the second opening 17 located where fitting 12 meets chamber 20. Second opening 17 allows water entering from hose 16 through first opening 15 to enter chamber 20. Water will then pass through chamber 20 into air chamber 24, at which point it may be aerated by air entering through air inlet 22. The water will then pass into main jet body 26 where it will proceed to exit jet assembly 10 and enter the spa. Flange 28 will allow jet assembly 10 to rest on the surface of an interior spa wall (not shown), while the rest of the assembly 10 will be secured behind a spa wall. Threads 30 allow the assembly to be movably secured into a wall fitting with corresponding threads.

The barb 13 also comprises hose stop 18 along its interior surface, which is proximate to second opening 17. Hose stop 18 may comprise a plurality of raised ridges that extend peripherally into the interior surface of barb 13 as shown. Alternatively, hose stop 18 may comprise a shoulder (not shown) that comprises a continuous raised surface along the interior of barb 13. These or similar features may be provided to prevent a hose, when placed in the inside of barb 13, from passing beyond fitting 12 into the chamber 20. Barb 13 further comprises an interior socket diameter 34 as shown in FIG. 3, with a preferred diameter of approximately 0.565 inches.

Barb 13 further comprises serrations 14 along its outer surface. Serrations 14 (as best shown in FIG. 2) extend peripherally away from body 13 and are sized to extend into the inner surface of hose 16, creating a snug fit and seal. The diameter 32 of barb 13 to the interior of serrations 14 is preferably slightly larger than the interior diameter 36 of hose 16, while the diameter of the serrated portion of barb 13 is similar or slightly larger than the interior diameter of hose 16.

As shown in FIGS. 3 and 4, a preferred diameter for the non-serrated portion of barb 13 is approximately 0.850 inches, while a preferred interior diameter of hose 16 is approximately 0.750 inches. Hose 16 is preferably made from an elastic material such that when one end is passed over fitting 12 and serrations 14, the walls of hose 16 flex outward until the end of hose 16 is in place over fitting 12 (best shown in FIG. 2), wherein the walls then flex back to their approximate original position to create a snug fit against fitting 12. To further ensure an adequate seal between fitting 12 and the interior of hose 16, adhesive may be used, with a water-resistant adhesive being preferable.

Because hose 16 is sized to fit over fitting 12 and thus has a larger interior diameter 36 than the diameter 34 of fitting 12, it is designed to carry more water to spa accessories that are larger in size and/or have greater water capacity than smaller spa accessories.

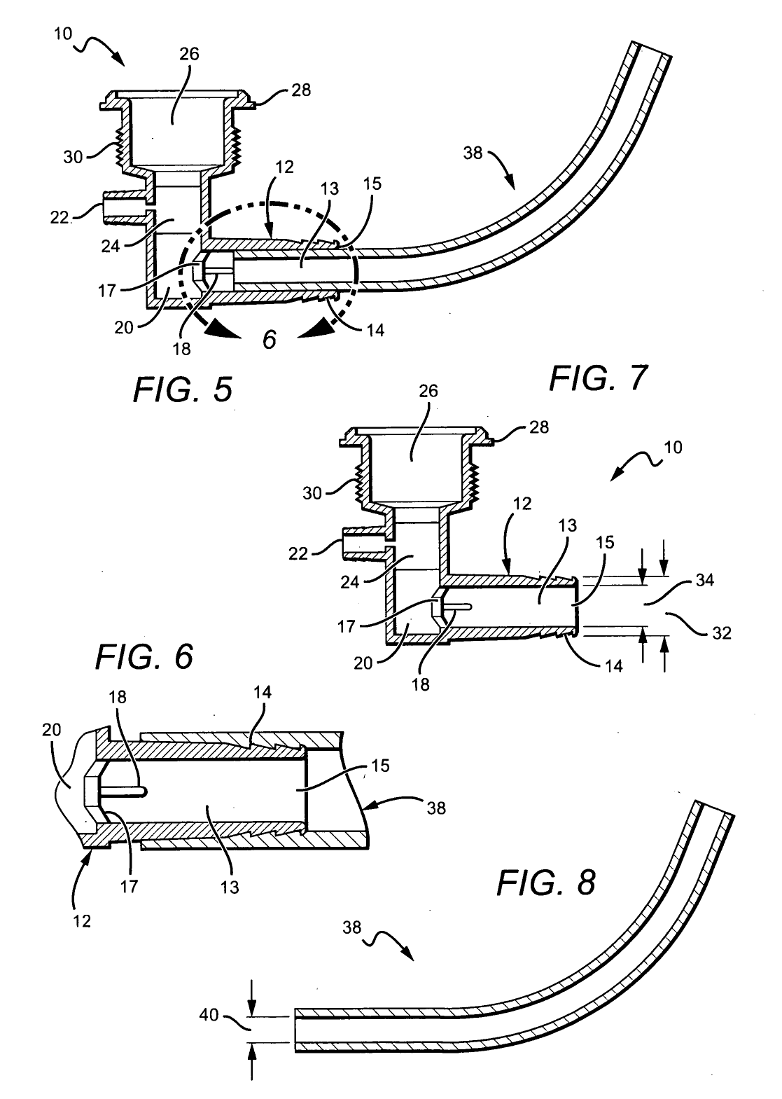

FIGS. 5-8 show another embodiment of the jet assembly 10 depicted in FIGS. 1-4, having fitting 12 with barb 13, first opening 15 and second opening 17, serrations 14, hose stop 18, water chamber 20, air inlet 22, air chamber 24, main jet body 26, flange 28, and threads 30. However, FIGS. 5-8 depict a different water supply hose 38, which is placed in the socket of barb 13 rather than outside. Hose 38 has a smaller diameter than hose 16, and is designed to accommodate spa jets and the like that are smaller and/or have less water capacity than jets accommodated by a larger hose like hose 16.

One end of hose 38 is placed through first opening 15 of the elongated cylindrical barb 13 of fitting 12 until it meets hose stop 18. Hose stop 18 prevents hose 38 from passing beyond fitting 12 into the chamber 20. As indicated above, hose stop 18 may comprise a plurality of ridges as shown, or may comprise a shoulder or the like. Hose 38 supplies water to jet assembly 10 through barb 13 and second opening 17 as described above with FIGS. 1-4.

Barb 13 comprises an interior socket diameter 34 as shown in FIG. 7, which is sized to accept hose 38 to create a snug fit and seal. The interior socket of barb 13 may have a preferred diameter of approximately 0.565 inches, which is approximately the same size as the diameter of hose 38. A preferred interior diameter 40 of hose 38 is approximately 0.375 inches. When one end of hose 38 is passed into the interior socket of barb 13, it is prevented from further inward movement by hose stop 18 (best shown in FIG. 6), wherein it is secured into position with a snug fit within fitting 12. To further ensure an adequate seal between fitting 12 and the exterior of one end of hose 38, water-resistant adhesive may be used.

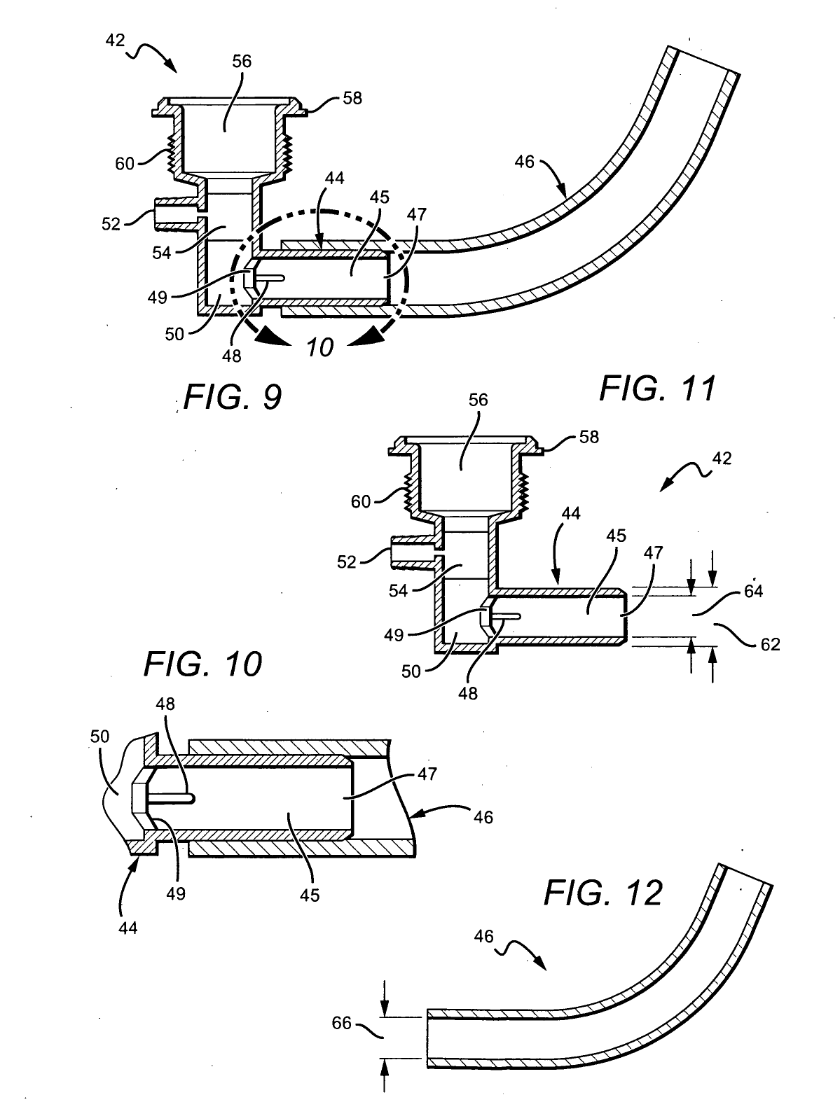

FIGS. 9-12 show one embodiment of a jet assembly 42 constructed in accordance with the present invention, having an inside/outside fitting 44 with a barb 45, first opening 47 and second opening 49, water supply hose 46, hose stop 48, water chamber 50, air inlet 52, air chamber 54, main jet body 56, flange 58, and threads 60. The jet assembly 42 and its components are made from the same materials and components as jet assembly 10, with the main difference being the lack of serrations on the outside of fitting 44. Instead, the external surface of the barb 45 of fitting 44 is substantially smooth.

One end of hose 46 is placed over the elongated cylindrical barb 45 extending peripherally from water chamber 50, with said barb 45 having a first opening 47 opening to the outside of jet assembly 42 to accept water flowing through hose 46. The barb 45 has a second opening 49, with the second opening 49 located where fitting 44 meets chamber 50. Second opening 49 allows water entering from hose 46 through first opening 47 to enter chamber 50. Water will then pass through chamber 50 into air chamber 54, at which point it may be aerated by air entering through air inlet 52. The water will then pass into main jet body 56 where it will proceed to exit jet assembly 42 and enter the spa. Flange 58 will allow jet assembly 42 to rest on the surface of an interior spa wall (not shown), while the rest of the assembly 42 will be secured behind a spa wall. Threads 60 allow the assembly to be movably secured into a wall fitting with corresponding threads.

Barb 45 further comprises hose stop 48 inside the interior socket of barb 45, wherein said stop 48 is provided to prevent a hose from being pushed beyond the fitting 44 into chamber 50. As indicated above with FIGS. 1-8, stop 48 may comprise ridges, a shoulder, or the like. Barb 45 further comprises an interior socket diameter 64 as shown in FIG. 11, with a preferred diameter of approximately 0.565 inches.

The diameter 62 of fitting 44 is preferably slightly larger than the interior diameter 66 of hose 46, which allows for a snug fit and seal when one end of hose 46 is passed over fitting 44. As shown in FIGS. 11 and 12, a preferred diameter for fitting 44 is approximately 0.798 inches, while a preferred interior diameter of hose 46 is approximately 0.750 inches. Hose 46 is preferably made from an elastic material such that when one end is passed over fitting 44, the walls of hose 46 flex outward until the end of hose 46 is in place over fitting 44 (best shown in FIG. 10), wherein the walls then flex back to their approximate original position to create a snug fit against fitting 44. To further ensure an adequate seal between fitting 44 and the interior of hose 46, water-resistant adhesive may be used. Because hose 46 is sized to fit over fitting 44 and thus has a larger interior diameter 66 than the interior diameter 64 of fitting 44, it is designed to carry more water to spa accessories that are larger in size and/or have greater water capacity than smaller spa accessories.

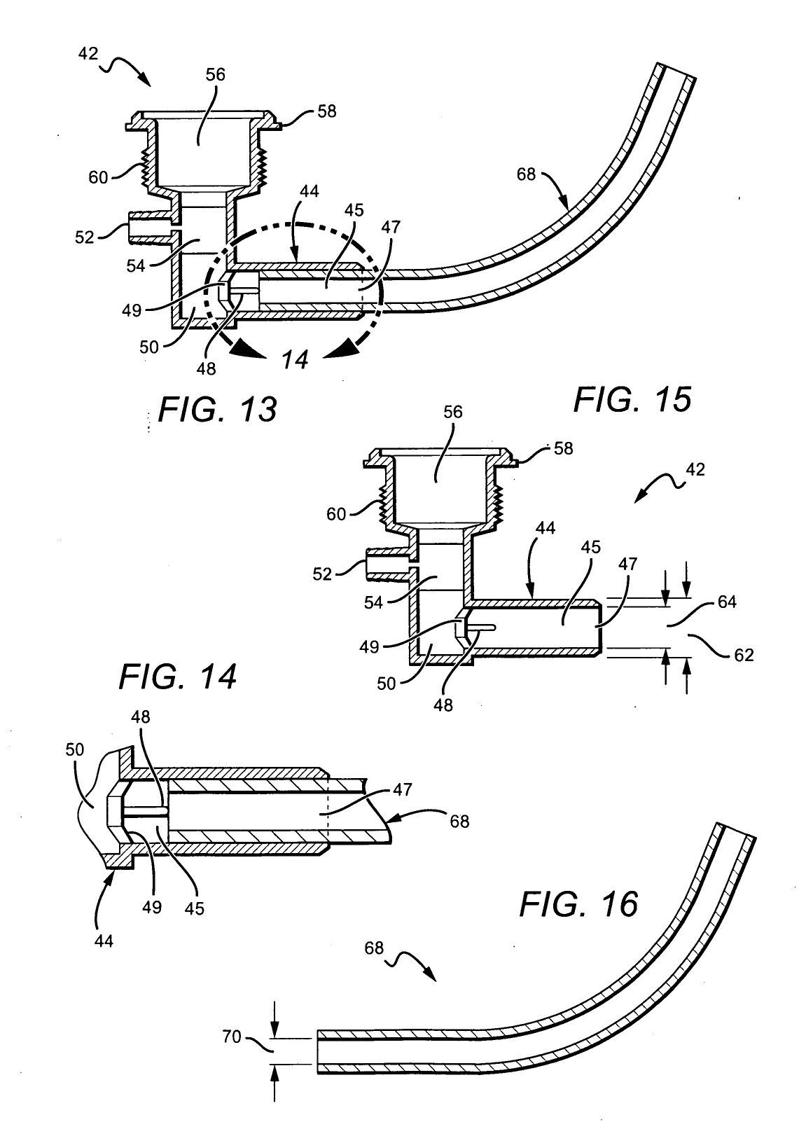

FIGS. 13-16 show another embodiment of the jet assembly 42 depicted in FIGS. 9-12, having fitting 44 with barb 45, first opening 47 and second opening 49, hose stop 48, water chamber 50, air inlet 52, air chamber 54, main jet body 56, flange 58, and threads 60. However, FIGS. 13-16 depict a different water supply hose 68, which is placed in the socket of barb 45 rather than outside. Hose 68 has a smaller diameter than hose 46, and is designed to accommodate spa jets and the like that are smaller and/or have less water capacity than jets accommodated by a larger hose like hose 46.

One end of hose 68 is placed through first opening 47 of the elongated cylindrical barb 45 of fitting 44 until it meets hose stop 48. Hose stop 48 prevents hose 68 from passing beyond fitting 44 into the chamber 50. As indicated above, hose stop 48 may comprise a plurality of ridges as shown, or may comprise a shoulder or the like. Hose 68 supplies water to jet assembly 42 through barb 45 and second opening 49 as described above with FIGS. 9-12.

Barb 45 comprises an interior socket diameter 64 as shown in FIG. 15, which is sized to accept hose 68 to create a snug fit and seal. The interior socket of barb 45 may have a preferred diameter of approximately 0.565 inches, which is approximately the same size as the diameter of hose 68. A preferred interior diameter 70 of hose 68 is approximately 0.375 inches. When one end of hose 68 is passed into the interior socket of barb 45, it is prevented from further inward movement by hose stop 48 (best shown in FIG. 14), wherein it is secured into position with a snug fit within fitting 44. To further ensure an adequate seal between fitting 44 and the exterior of one end of hose 68, water-resistant adhesive may be used.

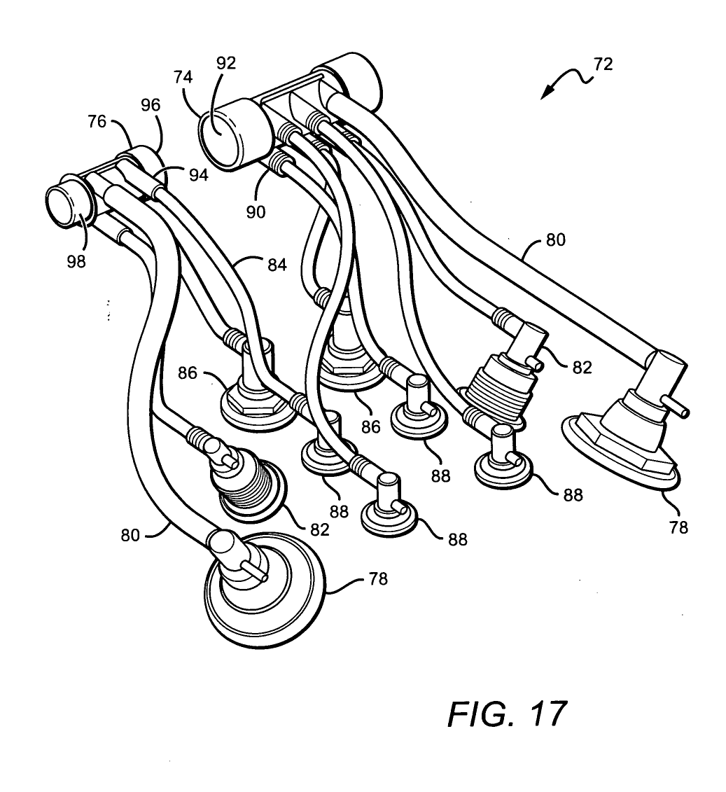

FIG. 17 depicts portions of a plumbing system 72 with a plurality of jets and manifolds utilizing the new inside/outside fittings according to the present invention. As shown in FIG. 17, various jets 78, 82, 86, 88 can be connected to manifolds 74, 76 comprising all or some of the new inside/outside fittings described above. Serrated fittings 90 and smooth fittings 94 can be located in any combination on manifolds 74 and 76 or jets 78, 82, 86, 88 and/or other spa accessories. Wider diameter hoses 80 can connect larger jets 78 to manifolds via hose placement outside of either serrated fittings 90 or smooth fittings 94. Smaller diameter hoses 84 can connect smaller and midsize jets 82, 86, 88 to manifolds via hose placement inside of either serrated fittings 90 or smooth fittings 94. Manifolds 74, 76 can have female ends such as end 92 and/or male ends such as end 98 which can be connected to other plumbing conduits or devices (not shown) with corresponding ends to form a full plumbing system for a spa.

In practice, water or a combination of water and air will be pumped through manifolds 74, 76 via a spa water pump assembly (not shown). Water will enter the manifolds 74, 76 through their end openings, where it will pass through fittings 90, 94 and into hoses 80, 84. The water will then be able to pass through any of the jet fittings and into jets 78, 82, 86, 88, where it will then flow into the interior of the spa via whatever jet or spa accessory is fitted to the plumbing system.

Although the present invention has been described in considerable detail with reference to certain preferred configurations and methods, other versions are possible. The invention can be used in many different types of spas. Different conduits, hoses, conduit/hose configurations, jets and spa accessories can be used in conjunction with the new inside/outside fittings, and a variable number of inside/outside fittings can be used to provide for any number of jet and/or spa accessory combinations utilizing a spa plumbing system. Therefore, the spirit and scope of the above description should not be limited to the versions described above.

We claim:

1. A jet assembly comprising:
a jet body;
one or more inside/outside fittings extending from said body, said one or more fittings being substantially hollow; and
at least one water supply hose, said hose sized to fit snugly inside said one or more hollow fittings or sized to fit snugly around the exterior of said one or more fittings.

2. The jet assembly of claim 1, wherein said jet body further comprises a water chamber.

3. The jet assembly of claim 2, wherein a stream of water provided from said at least one water supply hose enters said water chamber through one or more of said fittings and exits said jet body into a body of water.

4. The jet assembly of claim 1, wherein said jet body further comprises an air inlet extending peripherally away from said body.

5. The jet assembly of claim 4, wherein said jet body further comprises an air chamber, with air entering said air chamber through said air inlet to aerate a water stream.

6. The jet assembly of claim 1, wherein at least one of said inside/outside fittings comprises serrations extending peripherally away from the fitting to provide a snug fit and seal when one of said supply hoses is provided over said fitting.

7. The jet assembly of claim 1, wherein at least one of said inside/outside fittings comprises a hose stop to prevent one of said hoses from passing beyond the inside of said fitting into the interior of said jet body.

8. The jet assembly of claim 1, wherein at least one of said inside/outside fittings is substantially smooth along its outer surface.

9. The jet assembly of claim 1, wherein said jet body and said one or more inside/outside fittings are comprised of a water impervious plastic.

10. The jet assembly of claim 1, wherein said at least one hose is comprised of a clear vinyl.

11. The jet assembly of claim 1, wherein a standard ¾ inch diameter supply hose is sized to fit around the exterior of said one or more inside/outside fittings.

12. The jet assembly of claim 1, wherein a standard ⅜ inch diameter supply hose is sized to fit inside said one or more inside/outside fittings.

13. A plumbing system comprising:
a manifold comprising a main body;
a plurality of inside/outside fittings extending from said body;
a plurality of spa accessories, each of said accessories comprising at least one inside/outside fitting; and
a plurality of supply hoses, wherein one end of each said hose is sized to fit snugly inside or around the exterior of said manifold fittings, and wherein another end of each said hose is sized to fit snugly inside or around the exterior of said at least one spa accessory fittings.

14. The plumbing system of claim 13, wherein a stream of water is provided to said manifold, where it exits said manifold through at least one of said inside/outside fittings and flows through at least one of said hoses through at least one spa accessory inside/outside fitting, where it flows through said spa accessory and exits into a body of water.

15. The plumbing system of claim 13, wherein at least one spa accessory further comprises an air inlet extending peripherally away from a main body of the spa accessory, said air inlet provided to aerate a water stream.

16. The plumbing system of claim 13, wherein at least one of said fittings of said manifold and at least one of said fittings of a spa accessory comprise serrations extending peripherally away from the fitting to provide a snug fit and seal when one of said supply hoses is provided over said fitting.

17. The plumbing system of claim 13, wherein at least one of said fittings of said manifold and at least one of said fittings of a spa accessory comprise a hose stop to prevent one of said hoses from passing beyond the inside of said fitting into the interior of said manifold and/or said spa accessory.

18. The plumbing system of claim 13, wherein at least one of said fittings of said manifold and at least one of said fittings of a spa accessory is substantially smooth along its outer surface.

19. The plumbing system of claim 13, wherein said manifold and said plurality of spa accessories are comprised of a water impervious plastic.

20. The plumbing system of claim 13, wherein said plurality of hoses are comprised of a clear vinyl.

21. The plumbing system of claim 13, wherein a standard ¾ inch diameter water supply hose is sized to fit around the exterior of said inside/outside fittings of said manifold and said spa accessories.

22. The plumbing system of claim 13, wherein a standard ⅜ inch diameter water supply hose is sized to fit inside a hollow opening of said inside/outside fittings of said manifold and said spa accessories.

23. A method for a plumbing system comprising:
providing one or more manifolds each comprising a main body, wherein a plurality of inside/outside fittings extend from said main body;
providing one or more spa accessories each comprising a body, wherein each accessory comprises at least one inside/outside fitting extending from each said body;
providing one or more supply hoses, wherein each of said hoses can snugly fit either inside or around the exterior of said manifold and/or spa accessory inside/outside fittings; and
attaching one end of said one or more supply hoses to the inside or around the exterior of at least one of said manifold inside/outside fittings, and attaching the other end of said one or more supply hoses to the inside or around the exterior of at least one of said spa accessory inside/outside fittings.

24. The method of claim 23, further comprising attaching at least one of said manifolds to a water supply, water from said supply enabled to flow into each said manifold and out of each of said plurality of inside/outside fittings, said water flowing through each of said supply hoses into their respective inside/outside fittings of each said spa accessory, said water flowing into said body of each spa accessory and exiting each accessory into a body of water.

25. The method of claim 24, further comprising attaching two or more said manifolds either directly to each other or via one or more intervening plumbing pipes.

26. The method of claim 23, further comprising providing one or more of said hoses with first diameters sized to fit snugly over the exterior of each of said manifold and spa accessory fittings, and providing one or more said hoses with second diameters sized to fit snugly inside an opening of each of said manifold and spa accessory fittings.
